(19) United States
(12) Patent Application Publication
(10) Pub. No.: US 2026/0156543 A1
(43) Pub. Date: Jun. 4, 2026

(54) CONDITIONAL HANDOVER ENHANCEMENT WITH CANDIDATE TARGET CELL PRIORITIZATION

(71) Applicant: APPLE INC., Cupertino, CA (US)

(72) Inventors: Peng Cheng, Beijing (CN); Fangli Xu, Beijing (CN); Haijing Hu, Los Gatos, CA (US); Yuqin Chen, Beijing (CN)

(21) Appl. No.: 19/122,565

(22) PCT Filed: Nov. 3, 2022
(86) PCT No.: PCT/CN2022/129552

§ 371 Date: Apr. 18, 2025

(51) Int. Cl. H04W 36/00

(52) U.S. Cl. CPC H04W 36/0083; H04W 36/0058

(57) ABSTRACT

Methods and apparatus are provided for conditional handover (CHO) with prioritization of candidate target cells in a wireless network. A user equipment (UE) may receive, from a base station, a CHO configuration including configured priority values respectively associated with a set of the candidate target cells in the wireless network. The UE measures reference signals from the candidate target cells and reports corresponding measurement values to the base station. In a handover execution phase of a CHO procedure, the UE determines that a plurality of the candidate target cells satisfies a CHO condition, selects a target cell from among the plurality of the candidate target cells that satisfies the CHO condition based on a highest of the configured priority values or a default priority value, and completes a handover to the target cell.

### TECHNICAL FIELD

This application relates generally to wireless communication systems, including conditional handover with candidate target cell prioritization.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A and FIG. 1B together illustrate a flow diagram for conditional handover that may be used in some wireless communications systems.

FIG. 2 is a flowchart of a method of a UE for CHO with prioritization of candidate target cells in a wireless network according to one embodiment

FIG. 3 is a flowchart of a method of a base station in a wireless network according to one embodiment.

FIG. 4 illustrates an example architecture of a wireless communication system, according to embodiments disclosed herein.

FIG. 5 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network.

Therefore, the UE as described herein is used to represent any appropriate electronic component.

Possible techniques on the gNB and UE side may be utilized to improve network energy savings in terms of both base station transmission and reception. For example, efforts to achieve more efficient operation dynamically and/or semi-statically and for finer granularity adaptation of transmissions and/or receptions may use one or more of network energy saving techniques in time, frequency, spatial domain, and power domain, with potential support/feedback from the UE and potential UE assistance information and/or information exchange/coordination over network interfaces. Other techniques are not precluded and may prioritize, for example, Idle/Empty and low/medium load scenarios. Further, different loads among carriers and neighbor cells may be allowed.

### Conditional Handover

Conditional handover (CHO) is a feature introduced to improve mobility robustness. In CHO, the UE may be configured with a handover command and an associated condition to be monitored. The UE may execute the stored “handover” command when the associated condition(s) become true. Event conditions may include, for example, when a neighbor cell becomes better than a special cell (SpCell) by an offset (i.e., an A3 event condition) or when the SpCell becomes worse than a first threshold and the neighbor cell becomes better than a second threshold (i.e., an A5 event condition. The SpCell is the primary serving cell of either the Master Cell Group (MCG) or Secondary Cell Group (SCG), and the offset may be either positive or negative. When more than one candidate target cell satisfies the condition, it may be up to the UE implementation to determine which cell may execute handover (HO). In certain wireless communication systems (e.g., 3GPP Release 17), new conditional trigger conditions related to location and time may be defined to help enhance CHO for NR non-terrestrial networks (NTN).

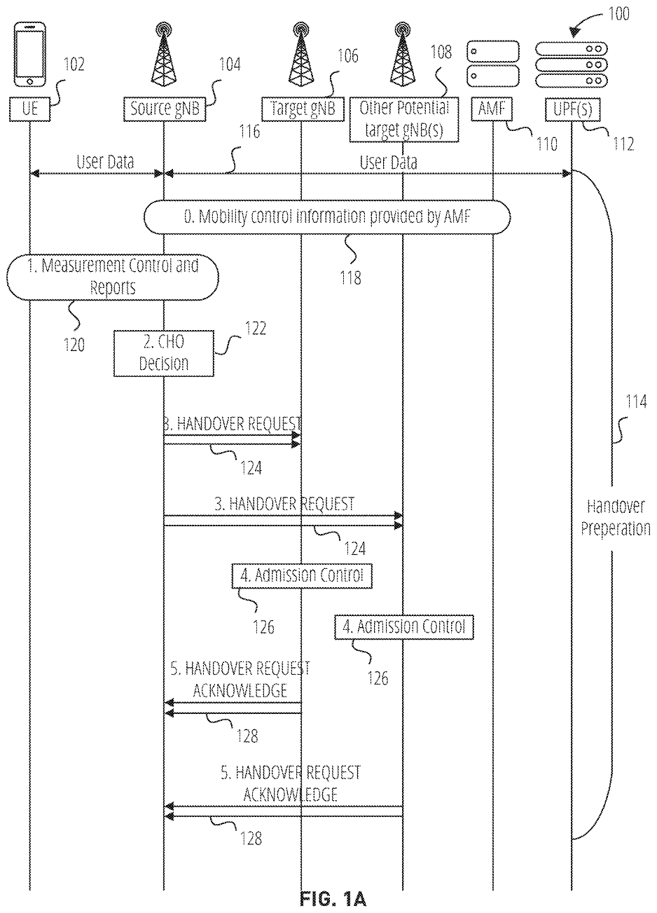

FIG. 1A and FIG. 1B together illustrate a flow diagram 100 for conditional handover that may be used in some wireless communications systems. The flow diagram 100 illustrates a wireless communication system that includes a UE 102, a source gNB 104, a target gNB 106, other potential target gNB(s) 108, an access and mobility management function (AMF) 110, and one or more user plane functions (UFP(s)) 112. As can be seen, the flow diagram 100 corresponds to an intra-AMF/UPF case.

As illustrated in FIG. 1A, the flow diagram 100 begins with the handover preparation phase 114. Presently, user data 116 is transported between the UE 102 and the source gNB 104 and between the source gNB 104 and the UFP(s) 112, as illustrated. The AMF 110 provides the source gNB 104 with mobility control information 118. Then, the source gNB* 104 configures measurements at the UE 102, and the UE 102 performs measurements and reports measurement results to the source gNB 104, during the measurement control and reports 120. Based on the receipt of the measurement reporting, the source gNB 104 makes a CHO decision 122. Based on the CHO decision 122, the source gNB 104 sends handover requests 124 to other gNBs (in the flow diagram 100, both the target gNB 106 that will ultimately be selected as the target of the handover and other potential target gNB(s) 108 are illustrated as receiving the handover requests 124).

The other gNBs (e.g., the target gNB 106 and the other potential target gNB(s) 108) each perform admission control 126, and reply to the source gNB 104 with a handover request acknowledgement 128, including configuration of any CHO candidate cell(s) at that gNB.

FIG. 1B continues the flow diagram 100 discussed above in relation to FIG. 1A. The source gNB 104 sends the UE 102 a radio resource control (RRC) reconfiguration message 130 having the configuration for the CHO candidate cells. The UE 102 sends the source gNB 104 an RRC reconfiguration complete message 132.

The flow diagram 100 then enters the handover execution phase 134. The UE 102 evaluates 136 the CHO condition. Further, in some embodiments (e.g., where early data forwarding is used) the target gNB 106 sends the other potential target gNB(s) 108 an early status transfer message 138.

Then, the UE 102 detaches 140 from the old cell and synchronizes to a new cell (e.g., on the target gNB 106). As part of this process, the UE performs an evaluation of conditions on the candidate cell(s) and determines that the new cell (on the target gNB 106) meets the conditions and that it will accordingly handover to that cell. The configuration for that new cell is then applied at the UE.

Further, user data 142 is transported between the UFP(s) 112 and the target gNB 106 and/or the other potential target gNB(s) 108 via the source gNB 104. The CHO handover completion 144 occurs once the UE 102 becomes associated with the new cell on the source gNB 104 (and the UE 102 may send an attendant RRC reconfiguration complete message to the target gNB 106).

The flow diagram 100 then enters the handover completion phase 146. First, the target gNB 106 sends the source gNB 104 a handover success message 148. Then, the source gNB 104 sends the target gNB 106 a sequence number (SN) status transfer 150. User data 152 is transported between the UFP(s) 112 and the target gNB 106 via the source gNB 104. Finally, the source gNB 104 may send the target gNB 106 and/or the other potential target gNB(s) 108 a handover cancel message 154.

### CHO enhancement for network energy saving

Certain wireless systems may attempt to enhance CHO with network energy saving (NES) cells. In an NES-state aware CHO (i.e., in CHO), the UE may take the cell NES states into account and could deprioritize and/or exclude a cell in the NES state when selecting a cell to hand over because the NES cell may have degraded performance (e.g., may be in a low power mode to save energy).

Certain embodiments herein provide prioritization or deprioritization in other cases beyond the NES case (e.g., for NTN cells vs. terrestrial network (NT) cells).

### CHO Enhancement With Candidate Target Cell Prioritization or Deprioritization

Certain embodiments provide a general CHO enhancement with candidate target cell prioritization or deprioritization. In a CHO configuration message (e.g., CHO-Config), a base station (e.g., gNB) may include different priority values for each candidate target cell. The priority value may be dedicated to each candidate target cell, or may be common to a group of candidate target cells.

In one embodiment, the base station determines how to set the priority value. The base station's intentions or reasons for selecting the priority value may be transparent to the UE. In one such embodiment, different priority values may be configured to different cell types. For example, the priority value may be based on whether the cell is an NES cell, an NTN cell, a TN cell, a mobile cell, a small cell, etc.

In another embodiment, different priority values may be configured to different cell states. For example, the priority value may be based on whether the cell is currently in a sleep state, a high loading, a state with low transmit power, etc.

In other embodiments, the base station may select the priority value for a cell based on a combination of cell types and cell states. For example, the base station may assign a higher priority value to a TN cell in a low loading state and a lower priority value to a small cell in a low transmit power state.

In certain embodiments, a default priority value is specified or preconfigured for candidate cells without a configuration of the priority value (e.g., legacy cells). The default value may be higher or lower than a configured priority value. For example, for priority value range of 0-7, a value of 3 may be specified as the default value.

In one embodiment, a UE may perform measurements towards candidate cells (e.g., during the measurement control and reports 120 in the handover preparation phase 114 of the CHO procedure shown in FIG. 1A) according to an order of configured or default priority values. Thus, limited measurement resources and power may be used to measure reference signals from the cells with the highest priority values. In certain cases, resources and power may be conserved (i.e., not used) by not measuring reference signals from the cells with the lowest priority values.

For HO execution (e.g., see the handover execution phase 134 of the CHO procedure shown in FIG. 1B), according to one embodiment, if more than one candidate target cells satisfy the CHO condition, the UE may select the cell with the highest configured or default priority value to execute HO. In certain such embodiments, if more than one candidate target cells has the highest configured or default priority value, it may be up to UE implementation to select one of the candidate target cells to execute HO.

In another embodiment for HO execution, the base station may configure a measurement delta threshold. If more than one candidate target cells satisfy the CHO condition, the UE is configured to: find the cell with the best measurement; for each candidate cell satisfying the condition, calculate a delta value between a measurement of the candidate cell and the best measurement; and among the cells whose delta value is smaller than the measurement delta threshold configured by the base station, select the cell with highest configured or default priority value to execute HO. In certain such embodiments, if more than one candidate target cells has the highest configured or default priority value, it may be up to UE implementation to select one of the candidate target cells to execute HO.

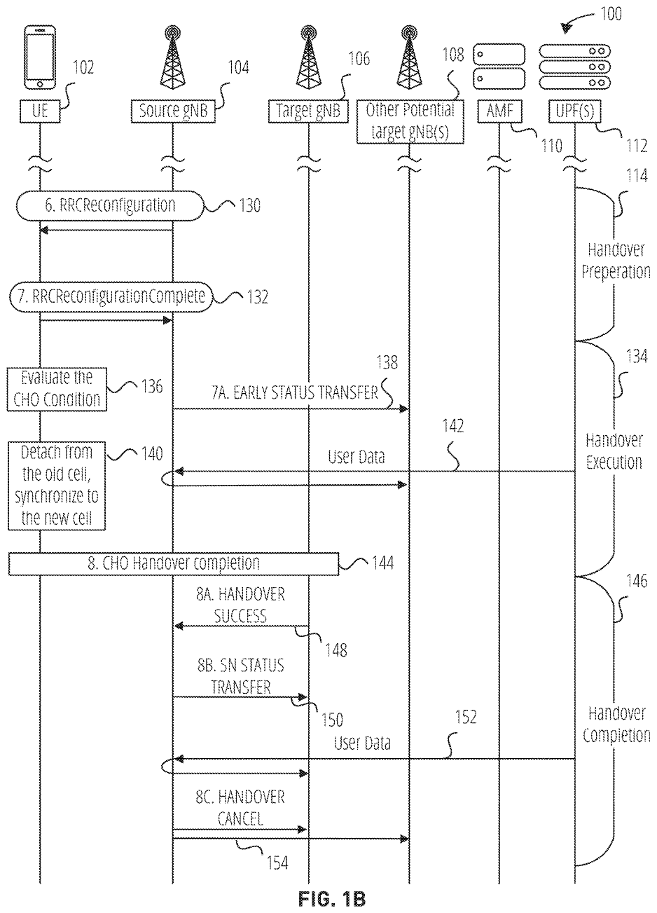

FIG. 2 is a flowchart of a method 200 of a UE for CHO with prioritization of candidate target cells in a wireless network according to one embodiment. In block 202, the method 200 includes receiving, from a base station, a CHO configuration comprising configured priority values respectively associated with a set of the candidate target cells in the wireless network. In block 204, the method 200 includes measuring reference signals from the candidate target cells and reporting corresponding measurement values to the base station. In block 206, in a handover execution phase of a CHO procedure, the method 200 includes determining that a plurality of the candidate target cells satisfies a CHO condition. In block 208, the method 200 includes selecting a target cell from among the plurality of the candidate target cells that satisfies the CHO condition based on a highest of the configured priority values or a default priority value. In block 210, the method 200 includes completing a handover to the target cell.

In one embodiment of the method 200, selecting the target cell further comprises: determining a measurement delta threshold value configured by the base station; in response to determining that the plurality of the candidate target cells satisfies the CHO condition: determining a best measurement value from among the corresponding measurement values; for the plurality of the candidate target cells that satisfies the CHO condition, calculating respective delta values between the corresponding measurement values and the best measurement value; and selecting the target cell from among a group of the plurality of the candidate target cells that satisfies the CHO condition comprising the respective delta values that are smaller than the measurement delta threshold value.

In one embodiment of the method 200, when two or more of the plurality of the candidate target cells that satisfies the CHO condition are associated with the highest of the configured priority values or the default priority value, selecting the target cell is further based on an autonomous UE selection.

In one embodiment of the method 200, measuring the reference signals from the candidate target cells comprises performing measurements towards the candidate target cells according to an order based on the configured priority values and the default priority value.

In one embodiment of the method 200, the default priority value corresponds to one or more of the candidate target cells that are not in the set of the candidate target cells associated with the configured priority values. The default priority value may be associated with a legacy UE. Alternatively, the default priority value may be fixed in a specification or configured in a subscription associated with the UE.

In one embodiment of the method 200, the configured priority values are based on different cell types. For example, the different cell types may be selected from a group comprising a network energy saving (NES) cell, a non-terrestrial network (NTN) cell, a terrestrial network (TN) cell, a mobile cell, a small cell, and other cell types. In one embodiment of the method 200, the configured priority values are based on different cell states. For example, the different cell states may be selected from a group comprising a network energy saving (NES) state, a sleep state, a high loading state, a low transmit power state, and other cell states.

In one embodiment of the method 200, the configured priority values are based on a combination of different cell types and different cell states.

Embodiments contemplated herein include an apparatus comprising means to perform one or more elements of the method 200. This apparatus may be, for example, an apparatus of a UE (such as a wireless device 502 that is a UE, as described herein).

Embodiments contemplated herein include one or more non-transitory computer-readable media comprising instructions to cause an electronic device, upon execution of the instructions by one or more processors of the electronic device, to perform one or more elements of the method 200. This non-transitory computer-readable media may be, for example, a memory of a UE (such as a memory 506 of a wireless device 502 that is a UE, as described herein).

Embodiments contemplated herein include an apparatus comprising logic, modules, or circuitry to perform one or more elements of the method 200. This apparatus may be, for example, an apparatus of a UE (such as a wireless device 502 that is a UE, as described herein).

Embodiments contemplated herein include an apparatus comprising: one or more processors and one or more computer-readable media comprising instructions that, when executed by the one or more processors, cause the one or more processors to perform one or more elements of the method 200. This apparatus may be, for example, an apparatus of a UE (such as a wireless device 502 that is a UE, as described herein).

Embodiments contemplated herein include a signal as described in or related to one or more elements of the method 200.

Embodiments contemplated herein include a computer program or computer program product comprising instructions, wherein execution of the program by a processor is to cause the processor to carry out one or more elements of the method 200. The processor may be a processor of a UE (such as a processor(s) 504 of a wireless device 502 that is a UE, as described herein). These instructions may be, for example, located in the processor and/or on a memory of the UE (such as a memory 506 of a wireless device 502 that is a UE, as described herein).

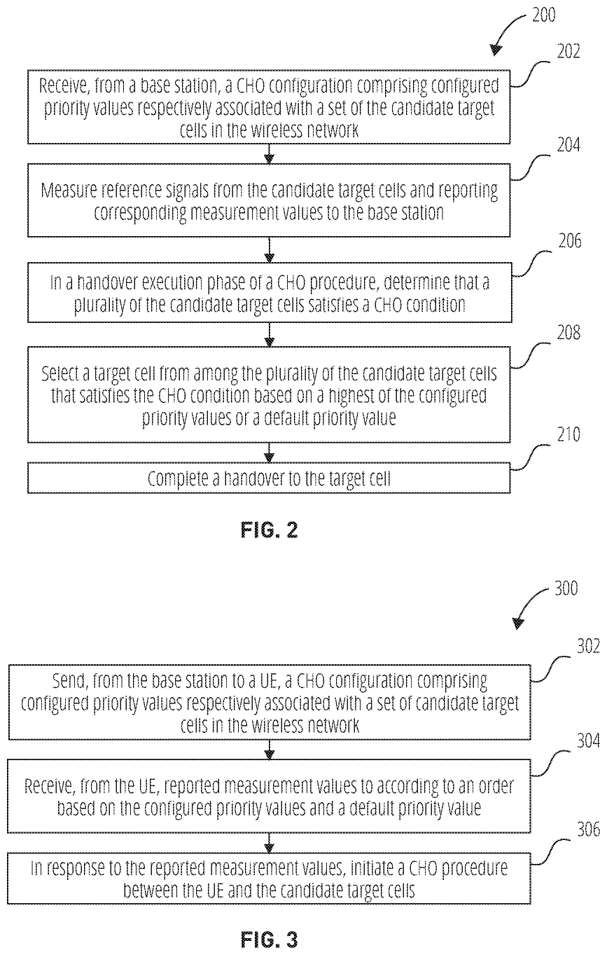

FIG. 3 is a flowchart of a method 300 of a base station in a wireless network according to one embodiment. In block 302, the method 300 includes sending, from the base station to a UE, a CHO configuration comprising configured priority values respectively associated with a set of candidate target cells in the wireless network. In block 304, the method 300 includes receiving, from the UE, reported measurement values to according to an order based on the configured priority values and a default priority value. In block 306, in response to the reported measurement values, the method 300 includes initiating a CHO procedure between the UE and the candidate target cells.

In one embodiment of the method 300, the configured priority values are dedicated, respectively, to each of the candidate target cells in the set.

In one embodiment of the method 300, at least one of the configured priority values is common to a group of the candidate target cells in the set.

In one embodiment of the method 300, the default priority value corresponds to one or more of the candidate target cells that are not in the set of the candidate target cells associated with the configured priority values. For example, the default priority value may be associated with a legacy UE. Alternatively, the default priority value is fixed in a specification or configured in a subscription associated with the UE. In such embodiments, the method 300 further comprises sending, from the base station to the UE, an indication of the default priority value.

In one embodiment, the method 300 further includes sending, from the base station to the UE, a measurement delta threshold value.

In one embodiment of the method 300, the configured priority values are based on different cell types. For example, the different cell types may be selected from a group comprising a network energy saving (NES) cell, a non-terrestrial network (NTN) cell, a terrestrial network (TN) cell, a mobile cell, a small cell, and other cell types.

In one embodiment of the method 300, the configured priority values are based on different cell states. For example, the different cell states may be selected from a group comprising a network energy saving (NES) state, a sleep state, a high loading state, a low transmit power state, and other cell states.

In one embodiment of the method 300, the configured priority values are based on a combination of different cell types and different cell states.

Embodiments contemplated herein include an apparatus comprising means to perform one or more elements of the method 300. This apparatus may be, for example, an apparatus of a base station (such as a network device 518 that is a base station, as described herein).

Embodiments contemplated herein include one or more non-transitory computer-readable media comprising instructions to cause an electronic device, upon execution of the instructions by one or more processors of the electronic device, to perform one or more elements of the method 300. This non-transitory computer-readable media may be, for example, a memory of a base station (such as a memory 522 of a network device 518 that is a base station, as described herein).

Embodiments contemplated herein include an apparatus comprising logic, modules, or circuitry to perform one or more elements of the method 300. This apparatus may be, for example, an apparatus of a base station (such as a network device 518 that is a base station, as described herein).

Embodiments contemplated herein include an apparatus comprising: one or more processors and one or more computer-readable media comprising instructions that, when executed by the one or more processors, cause the one or more processors to perform one or more elements of the method 300. This apparatus may be, for example, an apparatus of a base station (such as a network device 518 that is a base station, as described herein).

Embodiments contemplated herein include a signal as described in or related to one or more elements of the method 300.

Embodiments contemplated herein include a computer program or computer program product comprising instructions, wherein execution of the program by a processing element is to cause the processing element to carry out one or more elements of the method 300. The processor may be a processor of a base station (such as a processor(s) 520 of a network device 518 that is a base station, as described herein). These instructions may be, for example, located in the processor and/or on a memory of the base station (such as a memory 522 of a network device 518 that is a base station, as described herein).

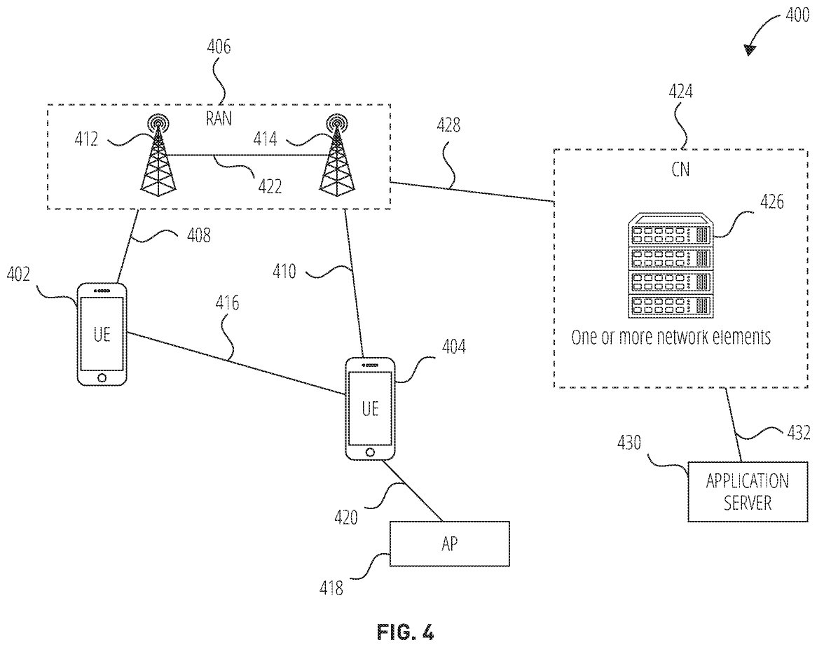

FIG. 4 illustrates an example architecture of a wireless communication system 400, according to embodiments disclosed herein. The following description is provided for an example wireless communication system 400 that operates in conjunction with the LTE system standards and/or 5G or NR system standards as provided by 3GPP technical specifications.

As shown by FIG. 4, the wireless communication system 400 includes UE 402 and UE 404 (although any number of UEs may be used). In this example, the UE 402 and the UE 404 are illustrated as smartphones (e.g., handheld touchscreen mobile computing devices connectable to one or more cellular networks), but may also comprise any mobile or non mobile computing device configured for wireless communication.

The UE 402 and UE 404 may be configured to communicatively couple with a RAN 406. In embodiments, the RAN 406 may be NG-RAN, E-UTRAN, etc. The UE 402 and UE 404 utilize connections (or channels) (shown as connection 408 and connection 410, respectively) with the RAN 406, each of which comprises a physical communications interface. The RAN 406 can include one or more base stations (such as base station 412 and base station 414) that enable the connection 408 and connection 410.

In this example, the connection 408 and connection 410 are air interfaces to enable such communicative coupling, and may be consistent with RAT(s) used by the RAN 406, such as, for example, an LTE and/or NR.

In some embodiments, the UE 402 and UE 404 may also directly exchange communication data via a sidelink interface 416. The UE 404 is shown to be configured to access an access point (shown as AP 418) via connection 420. By way of example, the connection 420 can comprise a local wireless connection, such as a connection consistent with any IEEE 802.11 protocol, wherein the AP 418 may comprise a Wi-Fi® router. In this example, the AP 418 may be connected to another network (for example, the Internet) without going through a CN 424.

In embodiments, the UE 402 and UE 404 can be configured to communicate using orthogonal frequency division multiplexing (OFDM) communication signals with each other or with the base station 412 and/or the base station 414 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 412 or base station 414 may be implemented as one or more software entities running on server computers as part of a virtual network. In addition, or in other embodiments, the base station 412 or base station 414 may be configured to communicate with one another via interface 422. In embodiments where the wireless communication system 400 is an LTE system (e.g., when the CN 424 is an EPC), the interface 422 may be an X2 interface. The X2 interface may be defined between two or more base stations (e.g., two or more eNBs and the like) that connect to an EPC, and/or between two eNBs connecting to the EPC. In embodiments where the wireless communication system 400 is an NR system (e.g., when CN 424 is a 5GC), the interface 422 may be an Xn interface. The Xn interface is defined between two or more base stations (e.g., two or more gNBs and the like) that connect to 5GC, between a base station 412 (e.g., a gNB) connecting to 5GC and an eNB, and/or between two eNBs connecting to 5GC (e.g., CN 424).

The RAN 406 is shown to be communicatively coupled to the CN 424. The CN 424 may comprise one or more network elements 426, which are configured to offer various data and telecommunications services to customers/subscribers (e.g., users of UE 402 and UE 404) who are connected to the CN 424 via the RAN 406. The components of the CN 424 may be implemented in one physical device or separate physical devices including components to read and execute instructions from a machine-readable or computer-readable medium (e.g., a non-transitory machine-readable storage medium).

In embodiments, the CN 424 may be an EPC, and the RAN 406 may be connected with the CN 424 via an S1 interface 428. In embodiments, the S1 interface 428 may be split into two parts, an S1 user plane (S1-U) interface, which carries traffic data between the base station 412 or base station 414 and a serving gateway (S-GW), and the S1-MME interface, which is a signaling interface between the base station 412 or base station 414 and mobility management entities (MMEs).

In embodiments, the CN 424 may be a 5GC, and the RAN 406 may be connected with the CN 424 via an NG interface 428. In embodiments, the NG interface 428 may be split into two parts, an NG user plane (NG-U) interface, which carries traffic data between the base station 412 or base station 414 and a user plane function (UPF), and the S1 control plane (NG-C) interface, which is a signaling interface between the base station 412 or base station 414 and access and mobility management functions (AMFs).

Generally, an application server 430 may be an element offering applications that use internet protocol (IP) bearer resources with the CN 424 (e.g., packet switched data services).

The application server 430 can also be configured to support one or more communication services (e.g., VoIP sessions, group communication sessions, etc.) for the UE 402 and UE 404 via the CN 424. The application server 430 may communicate with the CN 424 through an IP communications interface 432.

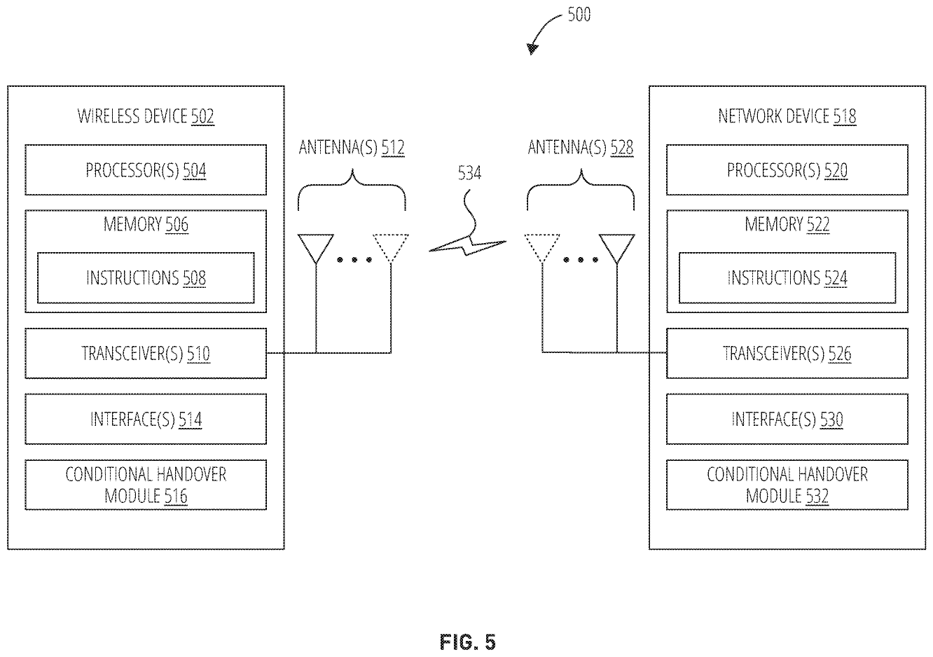

FIG. 5 illustrates a system 500 for performing signaling 534 between a wireless device 502 and a network device 518, according to embodiments disclosed herein. The system 500 may be a portion of a wireless communications system as herein described. The wireless device 502 may be, for example, a UE of a wireless communication system. The network device 518 may be, for example, a base station (e.g., an eNB or a gNB) of a wireless communication system.

The wireless device 502 may include one or more processor(s) 504. The processor(s) 504 may execute instructions such that various operations of the wireless device 502 are performed, as described herein. The processor(s) 504 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 502 may include a memory 506. The memory 506 may be a non-transitory computer-readable storage medium that stores instructions 508 (which may include, for example, the instructions being executed by the processor(s) 504). The instructions 508 may also be referred to as program code or a computer program. The memory 506 may also store data used by, and results computed by, the processor(s) 504.

The wireless device 502 may include one or more transceiver(s) 510 that may include radio frequency (RF) transmitter and/or receiver circuitry that use the antenna(s) 512 of the wireless device 502 to facilitate signaling (e.g., the signaling 534) to and/or from the wireless device 502 with other devices (e.g., the network device 518) according to corresponding RATs.

The wireless device 502 may include one or more antenna(s) 512 (e.g., one, two, four, or more). For embodiments with multiple antenna(s) 512, the wireless device 502 may leverage the spatial diversity of such multiple antenna(s) 512 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 502 may be accomplished according to precoding (or digital beamforming) that is applied at the wireless device 502 that multiplexes the data streams across the antenna(s) 512 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 502 may implement analog beamforming techniques, whereby phases of the signals sent by the antenna(s) 512 are relatively adjusted such that the (joint) transmission of the antenna(s) 512 can be directed (this is sometimes referred to as beam steering).

The wireless device 502 may include one or more interface(s) 514. The interface(s) 514 may be used to provide input to or output from the wireless device 502. For example, a wireless device 502 that is a UE may include interface(s) 514 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 510/antenna(s) 512 already described) that allow for communication between the UE and other devices and may operate according to known protocols (e.g., Wi-Fi®, Bluetooth®, and the like).

The wireless device 502 may include a Conditional Handover module 516. The Conditional Handover module 516 may be implemented via hardware, software, or combinations thereof. For example, the Conditional Handover module 516 may be implemented as a processor, circuit, and/or instructions 508 stored in the memory 506 and executed by the processor(s) 504. In some examples, the Conditional Handover module 516 may be integrated within the processor(s) 504 and/or the transceiver(s) 510. For example, the Conditional Handover module 516 may be implemented by a combination of software components (e.g., executed by a DSP or a general processor) and hardware components (e.g., logic gates and circuitry) within the processor(s) 504 or the transceiver(s) 510.

The Conditional Handover module 516 may be used for various aspects of the present disclosure, for example, aspects of FIG. 1A, FIG. 1B, and FIG. 2.

The network device 518 may include one or more processor(s) 520. The processor(s) 520 may execute instructions such that various operations of the network device 518 are performed, as described herein. The processor(s) 520 may include one or more baseband processors implemented using, for example, a CPU, a DSP, an ASIC, a controller, an FPGA device, another hardware device, a firmware device, or any combination thereof configured to perform the operations described herein.

The network device 518 may include a memory 522. The memory 522 may be a non-transitory computer-readable storage medium that stores instructions 524 (which may include, for example, the instructions being executed by the processor(s) 520). The instructions 524 may also be referred to as program code or a computer program. The memory 522 may also store data used by, and results computed by, the processor(s) 520.

The network device 518 may include one or more transceiver(s) 526 that may include RF transmitter and/or receiver circuitry that use the antenna(s) 528 of the network device 518 to facilitate signaling (e.g., the signaling 534) to and/or from the network device 518 with other devices (e.g., the wireless device 502) according to corresponding RATs.

The network device 518 may include one or more antenna(s) 528 (e.g., one, two, four, or more). In embodiments having multiple antenna(s) 528, the network device 518 may perform MIMO, digital beamforming, analog beamforming, beam steering, etc., as has been described.

The network device 518 may include one or more interface(s) 530. The interface(s) 530 may be used to provide input to or output from the network device 518. For example, a network device 518 that is a base station may include interface(s) 530 made up of transmitters, receivers, and other circuitry (e.g., other than the transceiver(s) 526/antenna(s) 528 already described) that enables the base station to communicate with other equipment in a core network, and/or that enables the base station to communicate with external networks, computers, databases, and the like for purposes of operations, administration, and maintenance of the base station or other equipment operably connected thereto.

The network device 518 may include a Conditional Handover module 532. The Conditional Handover module 532 may be implemented via hardware, software, or combinations thereof. For example, the Conditional Handover module 532 may be implemented as a processor, circuit, and/or instructions 524 stored in the memory 522 and executed by the processor(s) 520. In some examples, the Conditional Handover module 532 may be integrated within the processor(s) 520 and/or the transceiver(s) 526. For example, the Conditional Handover module 532 may be implemented by a combination of software components (e.g., executed by a DSP or a general processor) and hardware components (e.g., logic gates and circuitry) within the processor(s) 520 or the transceiver(s) 526.

The Conditional Handover module 532 may be used for various aspects of the present disclosure, for example, aspects of FIG. 1A, FIG. 1B, and FIG. 3.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE) for conditional handover (CHO) with prioritization of candidate target cells in a wireless network, the method comprising:
receiving, from a base station, a CHO configuration comprising configured priority values respectively associated with a set of the candidate target cells in the wireless network;
measuring reference signals from the candidate target cells and reporting corresponding measurement values to the base station;
in a handover execution phase of a CHO procedure:
determining that a plurality of the candidate target cells satisfies a CHO condition;
selecting a target cell from among the plurality of the candidate target cells that satisfies the CHO condition based on a highest of the configured priority values or a default priority value; and
completing a handover to the target cell.

2. The method of claim 1, wherein selecting the target cell further comprises:
determining a measurement delta threshold value configured by the base station;
in response to determining that the plurality of the candidate target cells satisfies the CHO condition:
determining a best measurement value from among the corresponding measurement values;
for the plurality of the candidate target cells that satisfies the CHO condition, calculating respective delta values between the corresponding measurement values and the best measurement value; and
selecting the target cell from among a group of the plurality of the candidate target cells that satisfies the CHO condition comprising the respective delta values that are smaller than the measurement delta threshold value.

3. The method of claim 1, wherein when two or more of the plurality of the candidate target cells that satisfies the CHO condition are associated with the highest of the configured priority values or the default priority value, selecting the target cell is further based on an autonomous UE selection.

4. The method of claim 1, wherein measuring the reference signals from the candidate target cells comprises performing measurements towards the candidate target cells according to an order based on the configured priority values and the default priority value.

5. The method of claim 1, wherein the default priority value corresponds to one or more of the candidate target cells that are not in the set of the candidate target cells associated with the configured priority values.

6. The method of claim 5, wherein the default priority value is associated with a legacy UE.

7. The method of claim 5, wherein the default priority value is fixed in a specification or configured in a subscription associated with the UE.

8. The method of claim 1, wherein the configured priority values are based on different cell types.

9. The method of claim 8, wherein the different cell types are selected from a group comprising a network energy saving (NES) cell, a non-terrestrial network (NTN) cell, a terrestrial network (TN) cell, a mobile cell, and a small cell.

10. The method of claim 1, wherein the configured priority values are based on different cell states.

11. The method of claim 10, wherein the different cell states are selected from a group comprising a network energy saving (NES) state, a sleep state, a high loading state, and a low transmit power state.

12. The method of claim 1, wherein the configured priority values are based on a combination of different cell types and different cell states.

13. A method of a base station in a wireless network, the method comprising:
sending, from the base station to a user equipment (UE), a conditional handover (CHO) configuration comprising configured priority values respectively associated with a set of candidate target cells in the wireless network;
receiving, from the UE, reported measurement values to according to an order based on the configured priority values and a default priority value; and
in response to the reported measurement values, initiating a CHO procedure between the UE and the candidate target cells.

14. The method of claim 13, wherein the configured priority values are dedicated, respectively, to each of the candidate target cells in the set.

15. The method of claim 13, wherein at least one of the configured priority values is common to a group of the candidate target cells in the set.

16. The method of claim 13, wherein the default priority value corresponds to one or more of the candidate target cells that are not in the set of the candidate target cells associated with the configured priority values.

17. The method of claim 16, wherein the default priority value is associated with a legacy UE.

18. The method of claim 16, wherein the default priority value is fixed in a specification or configured in a subscription associated with the UE.

19. The method of claim 16, further comprising sending, from the base station to the UE, an indication of the default priority value.

20. The method of claim 13, further comprising sending, from the base station to the UE, a measurement delta threshold value.

21-28. (canceled)
